(19) United States
(12) Patent Application Publication
(10) Pub. No.: US 2006/0059767 A1
(43) Pub. Date: Mar. 23, 2006

(54) Swimming fish emulation angling lure structure

(76) Inventor: Tsung-Hsi Tsai, Changhua City (TW)

Correspondence Address: TROXELL LAW OFFICE PLLC, SUITE 1404, 5205 LEESBURG PIKE, FALLS CHURCH, VA, 22041, US

(21) Appl. No.: 10/945,863

(22) Filed: Sep. 22, 2004

(51) Int. Cl. A01K 85/00

(52) U.S. Cl. 43/42.15

(57) ABSTRACT

A swimming fish emulation angling lure structure in which the angling lure is comprised of a fish head at the anterior half-section and a fish torso at the posterior half-section. When the fish torso is molded, it is a one-piece surrounding entity with steel strands and a hook ring inside and, furthermore, the fish torso comprises a plurality of contiguous fish torso units with a straight rib situated at the two sides of each fish torso unit such that the molded courses of the straight ribs showing along the exterior sides of the fish torso units surrounding the steel strands supplement the fish torso with even more pliant elasticity. The one-piece construction integrates a catch block at the front end when the fish torso is injection molded and, furthermore, after the catch block is first placed into the fish head receptacle, the two symmetrical lateral edges of the fish head are fitted together and bonded, the fish head and the fish torso thereby assembled into a unitary construct. As such, water current passing over the fish torso causes the angling lure of the invention herein to replicate the swimming action of actual fish at a high degree of realism and thereby induces fish to bite.

### BACKGROUND OF THE INVENTION

1) Field of the Invention

The invention herein relates to a swimming fish emulation angling lure structure in which when the fish torso is molded, it is a one-piece surrounding entity with steel strands and a hook ring inside and, furthermore, the fish torso comprises a plurality of contiguous fish torso units with a straight rib situated at the two sides of each fish torso unit such that the molded courses of the said straight ribs showing along the exterior sides of the fish torso units surrounding the steel strands supplement the fish torso with even more pliant elasticity. As such, water current passing over the fish torso causes the angling lure of the invention herein to replicate the swimming action of actual fish at a high degree of realism and thereby induces fish to bite.

2) Description of the Prior Art

Conventional fishing lures are typically solid objects having an external appearance resembling a fish. However, when such block-like solids are dragged through water, water current only flows pass the fishing lure which readily skips about in the water. As a result, getting fish to bite is difficult and numerous hooking opportunities are lost. In view of this, the applicant of the invention herein conducted extensive research that culminated in the successful development of the swimming fish emulation angling lure structure herein which is of significantly greater practical performance.

### BRIEF DESCRIPTION OF THE DRAWINGS

FIG. 1 is an exploded drawing of the invention herein.

FIG. 2 is an isometric drawing of the invention herein.

FIG. 3-A is a cross-sectional drawing of the invention herein.

FIG. 3-B is a cross-sectional drawing of the invention herein, as viewed from a lateral perspective.

FIG. 4 is an orthographic drawing of the flexile swaying embodiment of the invention herein.

### DETAILED DESCRIPTION OF THE PREFERRED EMBODIMENTS

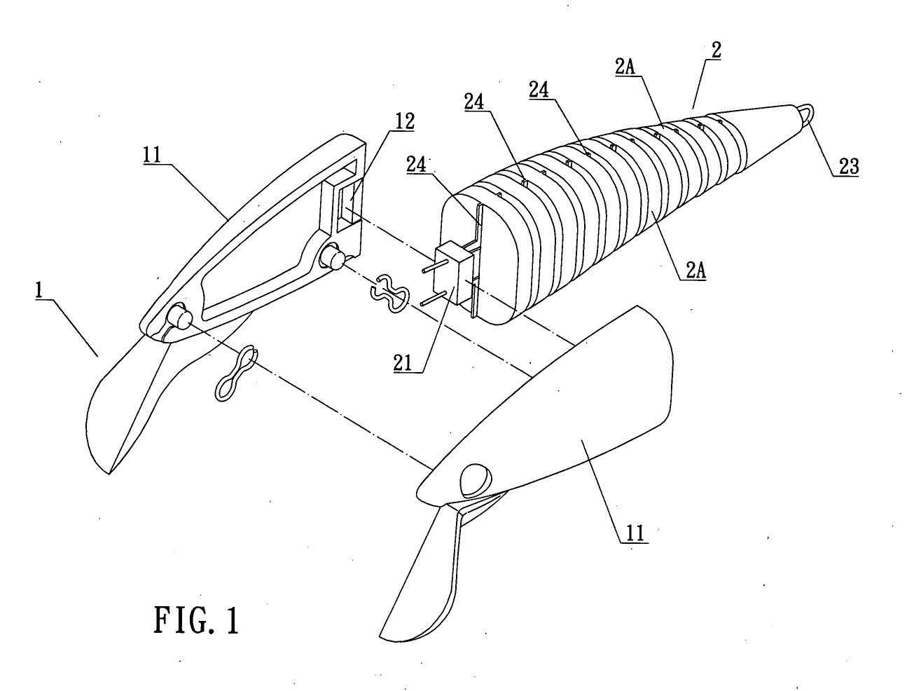

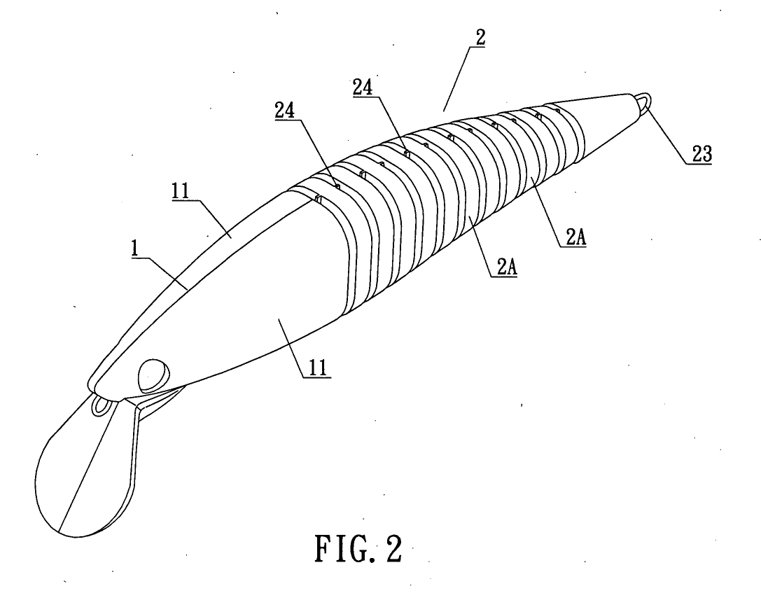

Referring to FIG. 1 and FIG. 2, the swimming fish emulation angling lure structure of the invention herein, the said angling lure is comprised of a fish head 1 at the anterior half-section and a fish torso 2 at the posterior half-section, wherein:

The said fish head 1 consists of two symmetrical lateral edges 11 that are fitted together and, furthermore, a receptacle 12 is disposed in the fish head 1 where it converges with trunk of the angling lure to provide for the insertion of the fish torso 2 catch block 21.

The said fish torso 2 consists of steel strands 22 that are pre-positioned lengthwise in its forming die, with a hook ring 23 affixed to the front end of the steel strands 22 and, furthermore, when the fish torso 2 is molded, the steel strands 22 are surrounded within the interior section of the fish torso 2 such that the hook ring 23 is exposed at the far extremity of the fish torso 2 to facilitate fish hook attachment; the fish torso 2 also consists of a plurality of fish torso units 2A disposed in a contiguous arrangement and, furthermore, a straight rib 24 is positioned at the two sides of each fish torso unit 2A, the molded courses of the said straight ribs 24 showing along the exterior sides of the fish torso units 2A surrounding the steel: strands 22 to supplement the fish torso 2 with even more pliant elasticity such that when moved through water, the agile swimming motions of a live fish are credibly imitated; moreover, the said fish torso 2 is equipped with a catch block 21 that projects from its front end and, furthermore, the catch block 21 is snap-locked into the fish head 1 receptacle 12.

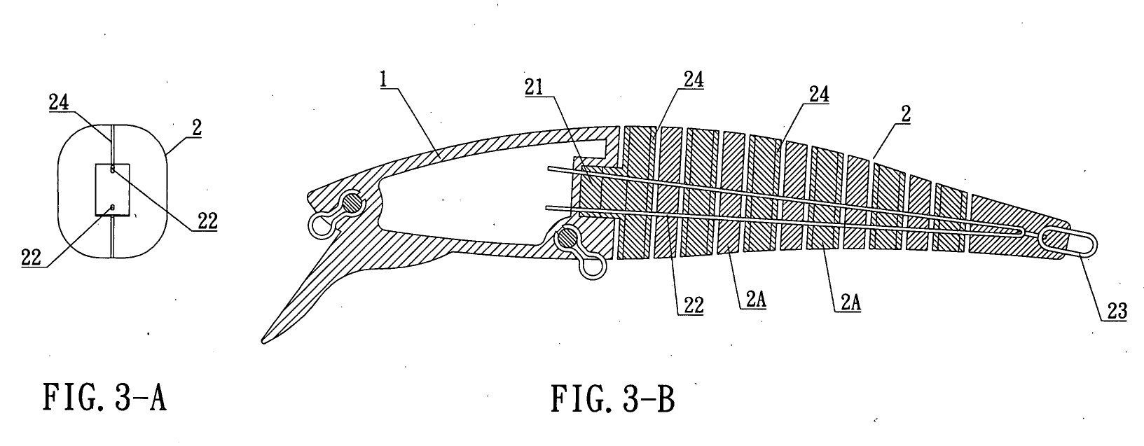

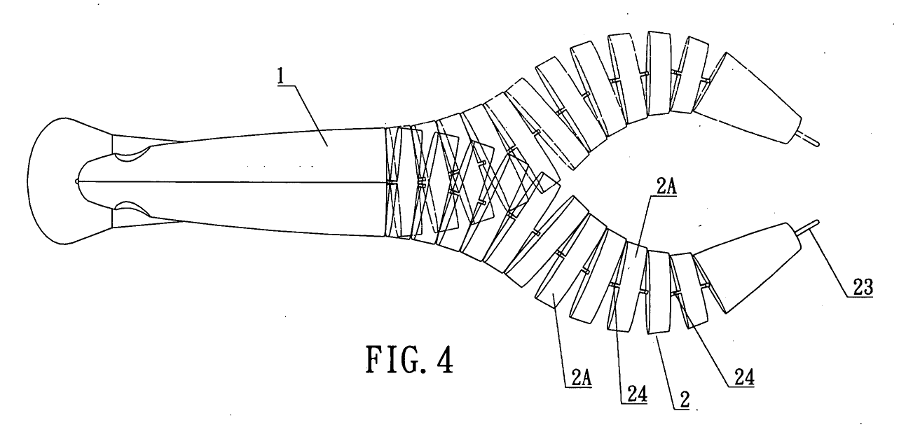

As for the fabrication method, refer to FIG. 3-A, FIG. 3-B, and FIG. 4; when the fish torso 2 is molded, it is a one-piece surrounding entity with the steel strands 22 and the hook ring 23 inside and, furthermore, the fish torso 2 comprises a plurality of contiguous fish torso units 2A with a straight rib 24 situated at the two sides of each fish torso unit 2A, enabling the waterborne fishing lure of the present invention to convincingly emulate a live swimming fish; moreover, since the one-piece construction integrates the catch block 21 at the front end when the said fish torso 2 is injection molded and, furthermore, after the catch block 21 is first placed into the fish head 1 receptacle 12, the two symmetrical lateral edges 11 of the fish head 1 are fitted together and bonded, the fish head 1 and the fish torso 2 thereby assembled into a unitary construct; as such, water current passing over the fish torso 2 causes the angling lure of the invention herein to replicate the swimming action of actual fish at a high degree of realism (as shown in FIG. 4) and thereby induces fish to bite.

1. A swimming fish emulation angling lure structure comprised of a fish head at the anterior half-section and a fish torso at the posterior half-section, wherein:
The said fish torso consists of steel strands that are pre-positioned lengthwise in its forming die, with a hook ring affixed to the front end of the said steel strands and, furthermore, when the said fish torso is molded, the said steel strands are surrounded within the interior section of the said fish torso such that the said hook ring is exposed at the far extremity of the said fish torso; the said fish torso also consists of a plurality of fish torso units disposed in a contiguous arrangement and, furthermore, a straight rib is positioned at the two sides of each said fish torso unit, the molded courses of the said straight ribs showing along the exterior sides of the said fish torso units surrounding the said steel strands to supplement the said fish torso with even more pliant elasticity for credibly imitating the agile swimming motions of a live fish.
As such, since water current passing over the said fish torso causes the angling lure of the invention herein to replicate the swimming action of actual fish at a high degree of realism, fish are induced to bite.

2. As mentioned in claim 1 of the swimming fish emulation angling lure structure of the invention herein, the said fish head consists of two symmetrical lateral edges that are fitted together.

3. As mentioned in claim 1 of the swimming fish emulation angling lure structure of the invention herein, the said fish head has a receptacle disposed where it converges with trunk of the angling lure and the said fish torso is equipped with a catch block that projects from its front end and, furthermore, the said catch block is snap-locked into the said fish head receptacle.

4. As mentioned in claim 2 of the swimming fish emulation angling lure structure of the invention herein, the said fish head has a receptacle disposed where it converges with trunk of the angling lure and the said fish torso is equipped with a catch block that projects from its front end and, furthermore, the said catch block is snap-locked into the said fish head receptacle.
